(19) United States
(12) Patent Application Publication
(10) Pub. No.: US 2011/0068095 A1
(43) Pub. Date: Mar. 24, 2011

(54) HEATING DEVICE CAPABLE OF CIRCULARLY HEATING AN OBJECT AT DIFFERENT TEMPERATURES

(76) Inventor: Jyh-Jian Chen, Pintung County (TW)

(21) Appl. No.: 12/694,889

(22) Filed: Jan. 27, 2010

(30) Foreign Application Priority Data
Sep. 24, 2009 (TW) 098132284

(51) Int. Cl. H05B 3/02

(52) U.S. Cl. 219/472

(57) ABSTRACT

A heating device includes: a housing configured with an accommodating space having a plurality of space parts; a heating unit disposed in the accommodating space in the housing and operable to generate heat so that temperature of air in each of the space parts of the accommodating space in the housing is maintained to a respective predetermined temperature; a casing configured with an inner receiving space for receiving an object to be heated therein; and a driving unit mounted to the housing for driving the casing to move back and forth in the accommodating space in the housing such that the casing received with the object therein circularly passes through the space parts, thereby circularly heating the object received in the casing at the predetermined temperatures.

### CROSS-REFERENCE TO RELATED APPLICATION

This application claims priority of Taiwanese Application No. 098132284, filed on Sep. 24, 2009.

### BACKGROUND OF THE INVENTION

1. Field of the Invention

The invention relates to a heating device, more particularly to a heating device capable of circularly heating an object at different temperatures.

2. Description of the Related Art

FIG. 1 illustrates a conventional heating device 1 for circularly heating a biochip sample (not shown) at different temperatures. The conventional heating device 1 includes a base seat 11 formed with an inner receiving space 111, a heating unit 12 disposed in the inner receiving space 111 and operable to generate heat, and a control unit 13 for controlling operation of the heating unit 12. The biochip sample is disposed in the inner receiving space 111 in the base seat 11, and is in thermal contact with the heating unit 12. The heating unit 12 is controlled by the control unit 13 to heat the biochip sample at different temperatures for heat-circulation purposes.

However, for the conventional heating device 1, transition of the heating unit 12 from one temperature to another temperature takes a period of time. As such, the biochip sample cannot be accurately heated during transition of the heat ing unit 12 such that predetermined heat-circulation cannot be ensured. Furthermore, the whole heating period is relatively long.

FIG. 2 illustrates another heating device 2 for circularly heating biochip samples (not shown) at different temperatures. The conventional heating device 2 includes a main body 21, three angularly equidistant heating members 22 mounted on the main body 21 for generating heat under respective temperature conditions, and a transporting tube 23 wound around the heating members 22 and filled with fluid 24 therein.

In use, the biochip samples are sent into the transporting tube 23 through an inlet 231 thereof. Then, by controlling a flow speed of the fluid 24 in the transporting tube 23, the biochip samples move toward an outlet 232 of the transporting tube 23 with flow of the fluid 24 such that the biochip samples are circularly heated by the heating members 22 under the temperature conditions. However, in such a configuration, since the transporting tube 23 is very long, remaining of the biochip samples in the transporting tube 23 cannot avoided.

### SUMMARY OF THE INVENTION

Therefore, an object of the present invention is to provide a heating device that can overcome the aforesaid drawbacks of the prior art.

According to the present invention, a heating device comprises:
a housing configured with an accommodating space that has a plurality of space parts;
a heating unit disposed in the accommodating space in the housing and operable to generate heat so that temperature of air in each of the space parts of the accommodating space in the housing is maintained to a respective predetermined temperature;
a heat-conducting casing configured with an inner receiving space that is adapted for receiving an object to be heated therein; and
a driving unit mounted to the housing for driving the casing to move back and forth in the accommodating space in the housing such that the casing received with the object therein circularly passes through the space parts, thereby circularly heating the object received in the casing at the predetermined temperatures.

### BRIEF DESCRIPTION OF THE DRAWINGS

Other features and advantages of the present invent ion will become apparent in the following detailed description of the preferred embodiment with reference to the accompanying drawings, of which:

FIG. 1 is a perspective view of a conventional heating device;

FIG. 2 is a perspective view of another conventional heating device;

FIG. 3 is a fragmentary perspective view showing the preferred embodiment of a heating device according to the present invention; and

FIG. 4 is a fragmentary schematic sectional view showing the preferred embodiment.

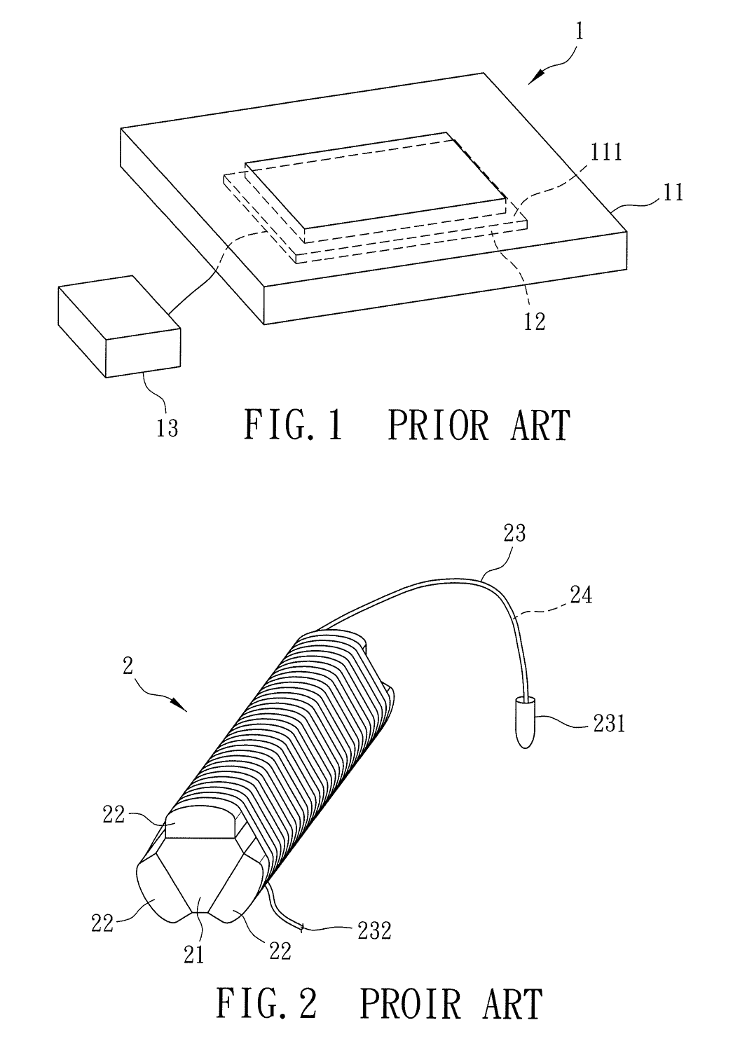

### DETAILED DESCRIPTION OF THE PREFERRED EMBODIMENT

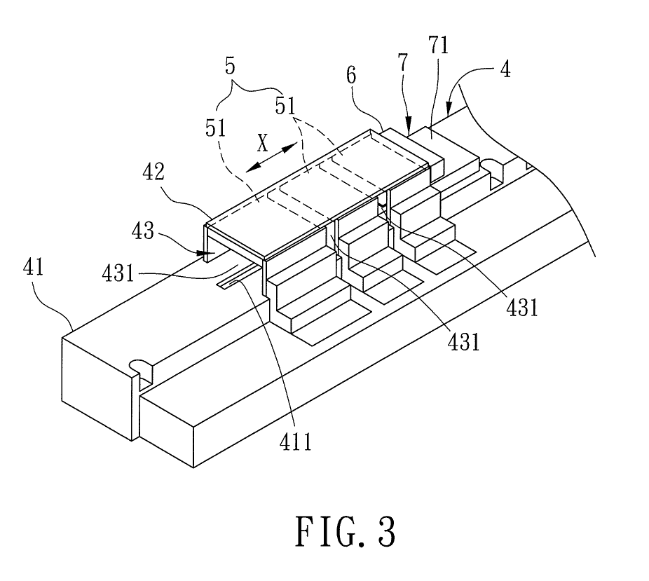

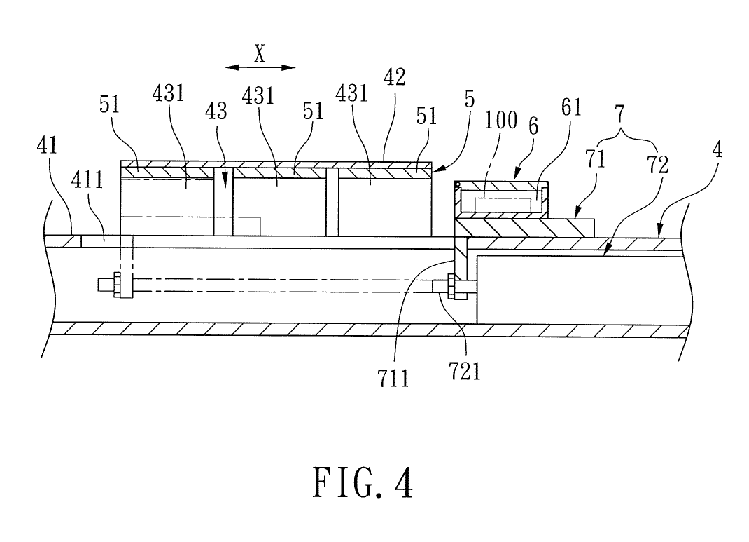

Referring to FIGS. 3 and 4, the preferred embodiment of a heating device according to the present invention is shown to include a housing 4, a heating unit 5, a heat-conducting casing 6, and a driving unit 7.

In this embodiment, the housing 4 includes a lower portion 41, and an upper portion 42 cooperating with the lower portion 41 to define an accommodating space 43 therebetween. The accommodating space 43 has a plurality of space parts 431 that is arranged in a direction (X). In this embodiment, the lower portion 41 has a top surface formed with a guiding groove 411 extending in the direction (X) and in spatial communication with the accommodating space 43.

The heating unit 5 is disposed in the accommodating space 43 in the housing 4. In this embodiment, the heating unit 5 includes a plurality of heating members 51. Each heating member 51 is disposed in a corresponding space part 431 of the accommodating space 43 in the housing 4, and is operable to generate heat so that temperature of air in the corresponding space part 431 of the accommodating space 43 in the housing 4 is maintained to a respective predetermined temperature.

The casing 6 is configured with a closed inner receiving space 61 adapted for receiving an object 100 to be heated, such as a biochip sample, therein.

The driving unit 7 is mounted to the housing 4 for driving the casing 6 to move back and forth in the accommodating space 43 in the housing 4. In this embodiment, the driving unit 7 includes a carrier 71 and a fluid cylinder 72. The carrier 71 is mounted on the top surface of the lower portion 41 of the housing for carrying the casing 6 thereon, and has an extension 711 that extends into the lower portion 41 of the housing 4 through the guiding groove 411. The fluid cylinder 72, such as a pneumatic cylinder, is disposed in the lower portion 41 of the housing 4, and has a piston rod 721 movable in the direction (X) and connected to the extension 711 of the carrier 71 such that the casing 6 is co-movable with an assembly of the carrier 71 and the piston rod 721. The fluid cylinder 72 is operable to move the piston rod 721 back and forth in the direction (X) such that the carrier 6 moves back and forth along the guiding groove 411 and that the casing 6 received with the object 100 therein is movable back and forth in the accommodating space 43 in the housing 4. As a result, the casing 6 circularly passes through the space part 431, thereby circularly heating the object 100 received in the casing 6 at the predetermined temperatures.

In sum, by controlling the driving unit 7, the casing 6 can exactly pass through each space part 431 of the accommodating space 43 within a desired time period. Therefore, the heating device of the present invention can circularly and accurately heat the object 100 received in the casing 6 at the predetermined temperatures within a relatively short heating period.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A heating device:
a housing configured with an accommodating space that has a plurality of space parts;
a heating unit disposed in said accommodating space in said housing and operable to generate heat so that temperature of air in each of said space parts of said accommodating space in said housing is maintained to a respective predetermined temperature;
a heat-conducting casing configured with an inner receiving space that is adapted for receiving an object to be heated therein; and
a driving unit mounted to said housing for driving said casing to move back and forth in said accommodating space in said housing such that said casing received with the object therein circularly passes through said space parts, thereby circularly heating the object received in said casing at the predetermined temperatures.

2. The heating device as claimed in claim 1, wherein:
said space parts are arranged in a direction; and
said driving unit includes
a carrier for carrying said casing thereon, and
a fluid cylinder disposed in said housing, and including a piston rod movable in the direction and connected to said carrier such that said casing is co-movable with an assembly of said carrier and said piston rod, said fluid cylinder being operable to move said piston rod back and forth in the direction such that said casing is movable back and fourth in said accommodating space in said housing based on movement of said piston rod.

3. The heating device as claimed in claim 1, wherein said heating unit includes a plurality of heating members, each of said heating member being disposed in a corresponding one of said space parts of said accommodating space in said housing and being operable to generate heat so that the temperature of air in the corresponding one of said space parts of said accommodating space in said housing is maintained to the respective predetermined temperature.
